(19) United States
(12) Patent Application Publication
(10) Pub. No.: US 2007/0260519 A1
(43) Pub. Date: Nov. 8, 2007

(54) Methods and apparatus for measurinfg the effect of online advertising on online user behavior

(76) Inventors: Bruce Robert Sattley, San Ramon, CA (US); Taylor Andrew Shreiner, San Francisco, CA (US); Ethan Evan Prater, San Mateo, CA (US); Mark Hunter Madsen, San Francisco, CA (US)

Correspondence Address: Stattler-Suh PC, 60 SOUTH MARKET, SUITE 480, SAN JOSE, CA, 95113, US

(21) Appl. No.: 11/601,273

(22) Filed: Nov. 17, 2006

Related U.S. Application Data
(63) Continuation of application No. 11/418,482, filed on May 4, 2006.

(51) Int. Cl. G06Q 30/00

(52) U.S. Cl. 705/14

(57) ABSTRACT

Described herein are methods and apparatus for measuring the effect of an online advertisement campaign on online behavior (searches relevant to the campaign and/or click activity on particular sponsored, algorithmic, and/or third-party links) of exposed users who have received a campaign advertisement. Online events of exposed and unexposed users are logged during a pre-campaign period (before any users receive any campaign advertisements) and a campaign period (when exposed users receive a campaign advertisement). A variety of behavior measurements and metrics may be determined using the logged user events. A metric may indicate the difference of an online activity between exposed and unexposed users during the campaign period or between exposed users during the pre-campaign and campaign periods. A metric may indicate the campaign's effect on an online activity by exposed users during the pre-campaign and campaign period in comparison to the online activity by unexposed users during the same periods.

### RELATED APPLICATIONS

This patent application claims benefit to and is a continuation of the United States patent application entitled “Methods and Apparatus for Measuring the Effect of Online Advertising on Online User Behavior,” having Ser. No. 11/418,482, filed on May 4, 2006.

### FIELD OF THE INVENTION

The present invention is directed towards the field of online advertising, and more particularly toward measuring the effect of online advertising on online user behavior.

### BACKGROUND OF THE INVENTION

Currently, advertising through computer networks such as the Internet is widely used along with advertising through other mediums, such as television, radio, or print. In particular, online advertising through the Internet provides a mechanism for merchants to offer advertisements for a vast amount of products and services to online users. In terms of marketing strategy, different online advertisements have different objectives depending on the user an advertisement is targeting.

FIG. 1 illustrates a marketing funnel that identifies three different marketing stages and objectives. At the top of the funnel, an advertiser may desire to acquire brand awareness for the advertiser's brand. Typically, for this type of marketing, branding advertisements are used to promote a brand for a product by associating one or more positive images with the brand. In a second stage of the funnel, advertisements are targeted for online users who are gathering information using the Internet for product consideration (sometimes referred to as “brand engagement”). To address this set of users, advertisers may use direct response advertisements whose objective is to elicit an action or response from the online user. For example, a direct response advertisement displayed on a web page may include a link for the user to “click” and go to an advertiser's web site. The last part of the funnel is where online users have a purchase intention. In this stage, the user is actively shopping, and intends to make a purchase or sign up for a service. For this set of users, advertisers may use purchase or sign up advertisements which may be a link that leads to a site for purchasing a product or signing up for a service.

Often, an advertiser will carry out an advertising campaign where a series of one or more advertisements are continually distributed over the Internet over a predetermined period of time (e.g., one month). Advertisements in an advertising campaign are typically branding advertisements but may also include direct response or purchasing advertisements. Currently, however, there are no methods for effectively measuring the impact of an online advertising campaign on later online user behavior.

### SUMMARY OF THE INVENTION

Described herein are methods and apparatus for measuring the effect of one or more online advertisements of an advertisement campaign on online behavior/activity of users (exposed users) who have received at least one of the online advertisements. The effect on one or more online user behaviors/activities can be measured, including relevant search activity or click activity on particular predetermined links (such as a sponsored link, an algorithmic advertiser link, or a priority link). As used herein, a campaign period refers to a predetermined period of time (e.g., three weeks) when a set of one or more exposed users receive an advertisement of the campaign, whereby a set of one or more users who do not receive an advertisement during the campaign period comprise a set of unexposed users. A pre-campaign period refers to a predetermined period of time (e.g., one month) prior to the campaign period when no users (neither the exposed nor unexposed users) receive an advertisement of the campaign. Further, a post-campaign period refers to a predetermined period of time (e.g., one month) after the campaign period when no users (neither the exposed nor unexposed users) receive an advertisement of the campaign.

In some embodiments, a metric is determined that indicates the disparity/difference of a particular online behavior (e.g., relevant search behavior) between exposed users and unexposed users during the campaign period. In other embodiments, a metric is determined that indicates the disparity/difference of a particular online behavior between exposed users during a campaign period (when the exposed users received an advertisement in the campaign) and a pre-campaign period (before the exposed users received any advertisement in the campaign).

In some embodiments, the effect of the campaign on the number of relevant search queries performed by exposed users is measured. In these embodiments, the set of advertisements of a campaign has an associated set of one or more keywords (e.g., where the keywords describe the set of advertisements or the advertiser's products or services). A search query performed by a user having at least one keyword in the set of keywords is considered a “relevant” search query, whereas a search query not having any keyword in the set of keywords is considered a “non-relevant” search query. A relevant search metric indicating the effect of the campaign may be calculated by determining the number of relevant searches performed by the exposed and unexposed users during the campaign period, whereby the relevant search metric reflects any disparity/difference between these numbers. In other embodiments, a relevant search metric may be calculated by determining the number of relevant searches by the exposed users in the pre-campaign period (before the exposed users receive one of the advertisements of the campaign) and determining the number of relevant searches by the exposed users during the campaign period (after they are exposed to one of the advertisements), whereby the relevant search metric reflects any disparity/difference between these numbers.

In some embodiments, the effect of the campaign on the number of selections of one or more particular predetermined links by exposed users is measured. The one or more predetermined links may include a sponsored advertiser link (a sponsored link that leads to a web page of the campaign advertiser), an algorithmic advertiser link (an algorithmic link that leads to a web page of the campaign advertiser), or a priority link (a specific predetermined link on the advertiser's web page). For each type of link (sponsored advertiser link, algorithmic advertiser link, or priority link), a link selection metric indicating the effect of the campaign may be calculated by determining the number of link selections performed by the exposed and unexposed users during the campaign period, whereby the link selection metric reflects any disparity/difference between these numbers. In other embodiments, a link selection metric may be calculated by determining the number of link selections by the exposed users in the pre-campaign period (before the exposed users receive one of the advertisements of the campaign) and determining the number of link selections by the exposed users during the campaign period (after they are exposed to one of the advertisements), whereby the link selection metric reflects any disparity/difference between these numbers.

In some embodiments, other values are used to calculate a metric, such as rate of occurrence of a search or link activity. For example, to calculate the relevant search metric, the number of relevant searches by the exposed users may be divided by the number of non-relevant searches by the exposed users to determine a rate of occurrence of relevant searches by exposed users. As another example, the number of relevant searches by the exposed users may be divided by the number of exposed users that are active on a particular network to determine a rate of occurrence of relevant searches by exposed users.

In other embodiments, a search or link selection metric can be determined using different sets of measurements. Also, a search or link selection metric can be determined using one or more other metrics. For example, a search or link selection metric may be calculated by:
determining a first value comprising the number of relevant searches or link selections divided by the number of active exposed users during the pre-campaign period;
determining a second value comprising the number of relevant searches or link selections divided by the number of active exposed users during the campaign period;
determining a third value (first metric) that indicates the difference between the first and second values, the third value reflecting the change in the number of relevant searches or link selections by exposed users from the pre-campaign period to the campaign period;
determining a fourth value comprising the number of relevant searches or link selections divided by the number of active unexposed users during the pre-campaign period;
determining a fifth value comprising the number of relevant searches or link selections divided by the number of active unexposed users during the campaign period;
determining a sixth value (second metric) that indicates the difference between the fourth and fifth values, the sixth value reflecting the difference between the number of relevant searches or link selections by the unexposed users from the pre-campaign period to the campaign period; and
determining a seventh value (third metric) comprising the difference between the third and sixth values (first and second metrics), the seventh value (third metric) reflecting the disparity/difference between the change between the number of relevant searches or link selections performed by the exposed users from the pre-campaign period to the campaign period and the change between the number of relevant searches or link selections performed by the unexposed users from the pre-campaign period to the campaign period.

As such, the seventh value (third metric) reflects the effect that the advertising campaign has on the number of relevant searches or link selections by an exposed set of users before and after being exposed to the advertising campaign in comparison to the number of relevant searches or link selections by a control set of users (unexposed users) during the same periods. These additional measurements may be undertaken to control for testing variables, such as the effect of other advertising campaigns of the advertiser that may be concurrently presented through other mediums (e.g., television, radio, etc.). By measuring the online behavior of a control set of users (unexposed users), the biasing effect of the advertising campaigns of the other mediums may be reduced.

In some embodiments, a relevant search or link selection metric also reflects the effect the advertisement campaign on the search behavior of exposed users during a post-campaign period after the campaign has ended and during which the exposed users no longer receive any advertisements of the campaign. In some embodiments, the number of relevant searches or link selections by the exposed and unexposed users during the post-campaign period are monitored and used to calculate relevant search or link selection metrics.

### BRIEF DESCRIPTION OF THE DRAWINGS

The novel features of the invention are set forth in the appended claims. However, for purpose of explanation, several embodiments of the invention are set forth in the following figures.

FIG. 1 illustrates a marketing funnel that identifies three different marketing stages and objectives.

FIG. 2 shows a network environment in which some embodiments operate.

FIG. 3 shows a conceptual diagram of a behavior-metrics processing system.

FIG. 4 is a conceptual diagram of a process for recording/logging online behavior of users during an advertisement campaign.

FIG. 5 is an exemplary graph of measurements determined for accumulated user event data during pre-campaign, campaign, and post-campaign time periods.

FIGS. 6A-6D are exemplary tables illustrating the different behavior measurements and metrics that may be determined from accumulated user event data.

FIGS. 7A-B are flowcharts of a method for measuring the effect of an online advertisement campaign on the online behavior of users who have received at least one advertisement.

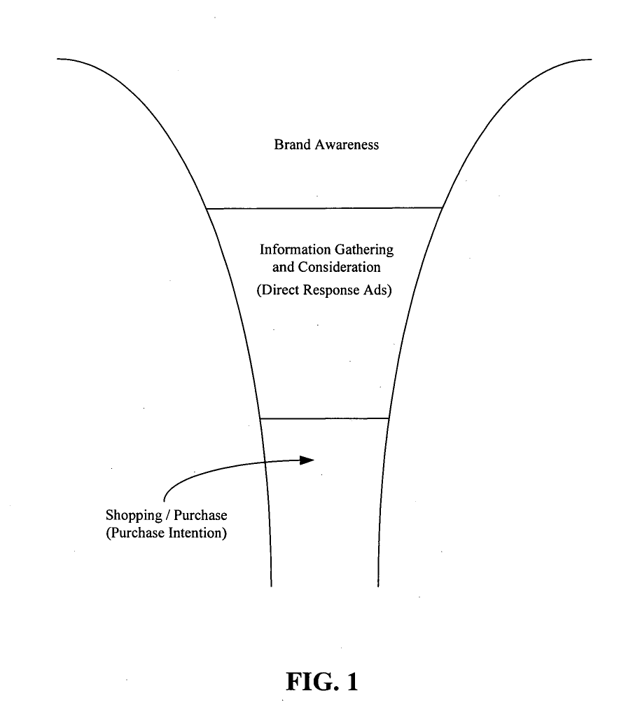

### DETAILED DESCRIPTION

The disclosure of United States patent application entitled “Methods and Apparatus for Measuring the Effect of Online Advertising on Online User Behavior,” having Ser. No. 11/418,482, filed on May 4, 2006, is expressly incorporated herein by reference.

In the following description, numerous details are set forth for purpose of explanation. However, one of ordinary skill in the art will realize that the invention may be practiced without the use of these specific details. In other instances, well-known structures and devices are shown in block diagram form in order not to obscure the description of the invention with unnecessary detail.

In the discussion below, Section I provides a general description of a network environment in which a behavior-metrics processing system operates. Section II describes a first stage where user events (e.g., search and click activity) of users exposed and not exposed to an online advertisement campaign are logged and accumulated. Section III describes a second stage where user behavior measurements and metrics are determined using the accumulated user events to indicate the effect of the online advertisement campaign. Section IV describes a method for logging search and click activity events of users exposed and not exposed to the campaign and determining measurements and metrics to indicate the effect of the campaign.

### I. Network Environment and Behavior-Metrics Processing System

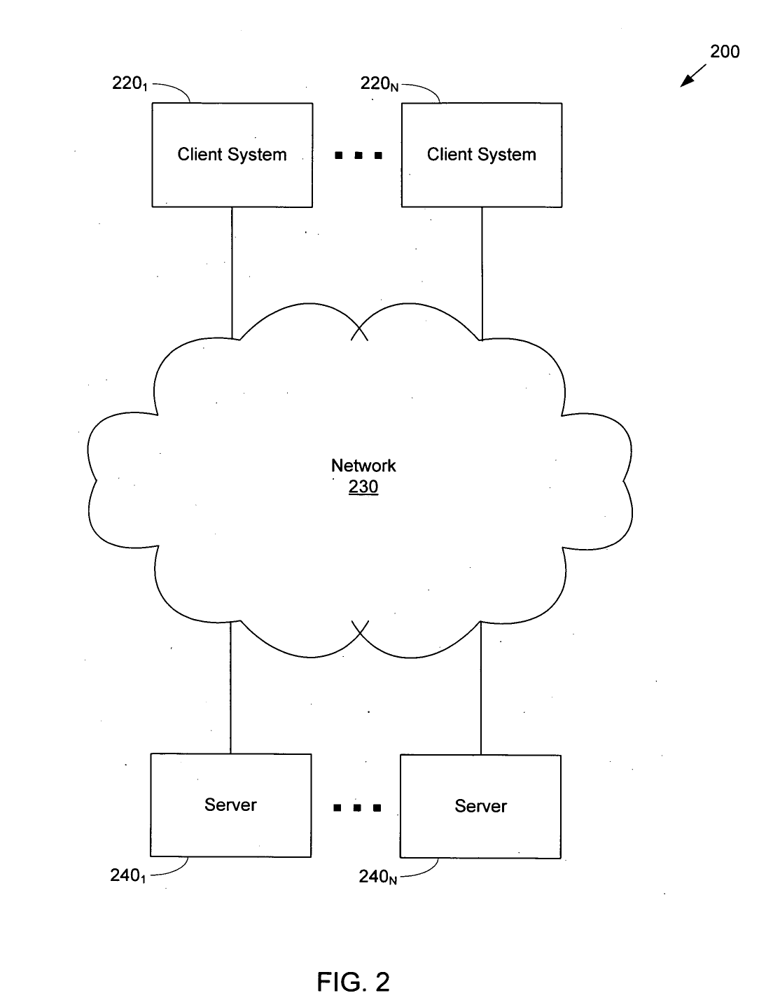

FIG. 2 shows a network environment 200 in which some embodiments operate. The network environment 200 includes a plurality of client systems 220₁ to 220_{N} coupled to a network 230 (such as the Internet or an intranet, an extranet, a virtual private network, a non-TCP/IP based network, any LAN or WAN, or the like) and server systems 240₁ to 240_{N}. A server system may include a single server computer or number of server computers. The client system 220 is configured to communicate with any of server systems 240₂ to 240_{N}, for example, to request and receive content (e.g., in the form of a web page).

The client system 220 may include a desktop personal computer, workstation, laptop, PDA, cell phone, any wireless application protocol (WAP) enabled device, or any other device capable of communicating directly or indirectly to a network. The client system 220 typically runs a web browsing program (such as Microsoft's Internet Explorer™ browser, Netscape's Navigator™ browser, Mozilla™ browser, Opera™ browser, a WAP-enabled browser in the case of a cell phone, PDA or other wireless device, or the like) allowing a user of the client system 220 to submit searches, link selections, and request and receive content from server systems 240₂ to 240_{N} over network 230. A unique identifier (e.g., cookie) is typically stored on the browsing program to uniquely identify the client system 220.

A client system 220 typically includes one or more user interface devices (such as a keyboard, a mouse, a roller ball, a touch screen, a pen or the like) for interacting with a graphical user interface (GUI) of the web browser on a display (e.g., monitor screen, LCD display, etc.). The user of a client system can be a human user interacting with a user interface of a computer that transmits requests (e.g., search queries or clicks on hyperlinks) for content. The user could also be another computer process or system that generates and transmits the request for base content programmatically. As used herein, the terms user and client system may be used interchangeably.

The client system 220 is used to request and receive base content from a server 240. Base content may be presented, for example, as a web page and may include a variety of content, such as news articles, emails, or search results (e.g., in the form of text or hyperlinks). Advertisements for products or services are typically sent to users along with base content requested by the user. As used herein, a client system 220/user is considered “active on a network” when it is interacting with a server on a network (such as servers 240₁ to 240_{N} on the network 230).

Base content and advertisements may be in a variety of forms including text, images, video, audio, animation, program code, data structures, hyperlinks (e.g., sponsored link, algorithmic links, integrated link, inside link, or the like), etc. The base content and advertisements may be formatted according to the Hypertext Markup Language (HTML), the Extensible Markup Language (XML), Standard Generalized Markup Language (SGML), or any other language.

As used herein, a base content provider is a network service provider (e.g., Yahoo! News, Yahoo! Music, Yahoo! Finance, Yahoo! Movies, Yahoo! Sports, etc.) that operates one or more servers that contain base content and receives requests for and transmits base content. A base content provider may also receive search queries and link selections from users and send advertisements to users. In some embodiments, a base content provider employs methods for measuring the effect of the advertisements on the online behavior of users who receive the advertisements. In some embodiments, the methods are implemented by one or more servers operated by a base content provider. In some embodiments, the client systems 220₁ to 220_{N} and/or system servers 240₁ to 240_{N} are configured to perform the methods described herein. The methods of some embodiments may be implemented in software or hardware.

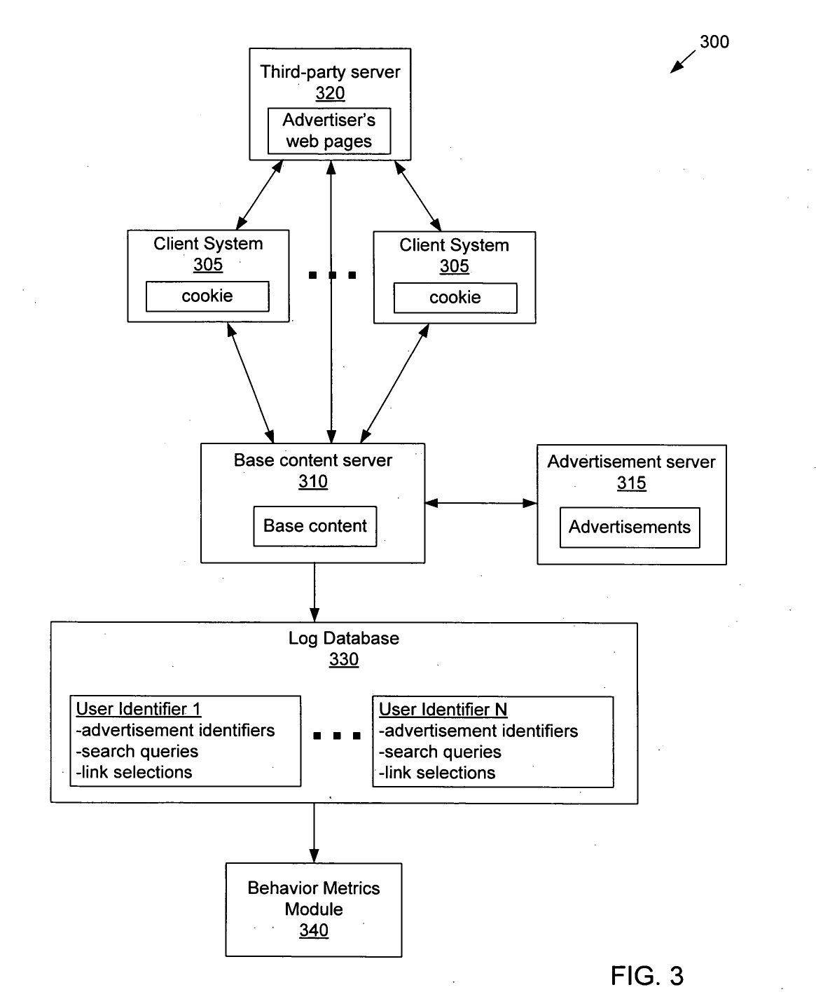

FIG. 3 shows a conceptual diagram of a behavior-metrics processing system 300. The behavior-metrics processing system 300 includes a plurality of client systems 305, a base content server 310 (containing base content), an advertisement server 315 (containing advertisements), a third-party server 320, a log database 330, and a behavior metrics module 340. The behavior-metrics processing system 300 is configured to measure the effect of advertisements on particular online behaviors of users/client systems who have received an advertisement. Various portions of the behavior-metrics processing system 300 may reside in one or more servers (such as servers 240₁ to 240_{N}) and/or one or more client systems 305.

The client system 305 is configured (e.g., via a web browsing program) to interact with a user to receive requests for base content (e.g., through search queries and selections/clicks of hyperlinks) from the user. The client system 305 is also configured to send the requests for base content to the base content server 310, receive the base content and advertisements from the base content server 310, and display the base and advertisements to the user (e.g., as a published web page). When receiving a request for base content, the base content server 310 sends the requested base content (e.g., search results such as algorithmic links) and retrieves one or more advertisements from the advertisement server 315 to also send to the client system 305.

The advertisement server 315 contains advertisements for various advertisers. An advertisement may comprise text, images, video, audio, hyperlinks (e.g., sponsored link), etc. Each advertisement in the advertisement server 315 is identified by a unique advertisement identifier. In some embodiments, an advertising campaign of an advertiser comprises a set of one or more advertisements that are to be served to users for a predetermined period of time (i.e., campaign period). The set of advertisements of the campaign have an associated set of one or more keywords that describe the set of advertisements. A keyword can comprise a single word (e.g., “cars,” “television,” etc.) or a plurality of words (e.g., “car dealer,” “New York City,” etc.). For example, a set of advertisements for a sports car campaign may have associated keywords “sports car,” “luxury car,” “high performance car,” etc. The keywords associated with the set of advertisements may be selected by the advertiser of the campaign or by other means. In some embodiments, the keywords associated with the set of advertisements comprise terms specific to the set of advertisements or products or services of the advertiser and does not include generic terms.

The base content server 310 selects particular users/client system (referred to as exposed users) that are to receive an advertisement in the campaign and selects particular users/client system (referred to as unexposed users) that are not to receive an advertisement in the campaign. When receiving a request for base content for a user designated as an exposed user, the base content server 310 then retrieves the requested base content and one or more advertisements in the campaign from the advertisement server 315, and sends the base content and the one or more advertisements to the user/client system.

In some embodiments, a client system 305 also interacts with a third-party server 320 that stores and serves web pages of the advertiser of the campaign. The client system 305 may be directed to the web pages of the advertiser by selecting links (e.g., sponsored or algorithmic links) received from the base content server 310. However, the client system 305 may be directed to the web pages of the advertiser by other means (such as direct input of the advertiser's web address by the user after the user has seen an advertisement containing such). While interacting with the web pages of the advertiser, the client system 305 may select links (including priority links discussed below) presented on the web pages. The third-party server 320 is typically operated or owned by an entity that is different from the entity operating or owning the base content server 310. The third-party server 320 is typically operated or owned by the advertiser, but may be operated by another entity.

During interaction with a client system/user, the base content server 310 determines or assigns a unique user identifier for the client system/user. In some embodiments, the user identifier may be stored, for example, in a cookie on the browser of the client system 305. The base content server 310 uses the user identifier of a client system 305 to uniquely identify the client system 305 and record interaction with the client system 305 along with the times and dates of the interaction to the log database 330. Recording interaction with a client system 305 and times and dates of the interaction is referred to as logging user/client system events.

In some embodiments, the client system events that are logged by the base content server 310 and associated with a user identifier of the client system include advertisement identifiers of advertisements sent to the client system 305 (with time and date sent) and search queries and hyperlink selections received from the client system 305 (with time and date received). The advertisement identifiers of advertisements sent to the client system 305 can be used by the behavior metrics module 340 to determine which users/client systems are exposed and non-exposed users/client systems (e.g., by comparing the advertisement identifiers to the advertisement identifiers for the advertisements in the campaign).

In some embodiments, the base content server 310 also uses the user identifier of a client system 305 to log interaction between the client system 305 and a third-party server 320. In some embodiments, the base content server 310 logs selections by the client system 305 of one or more predetermined links (priority links) on one or more web pages of the campaign advertiser served by the third-party server 320. A priority link may be, for example, a link that leads to a web page for eliciting a particular action by the user, such as buying a product or signing up for a service or account of the advertiser. Various methods known in the art may be used to monitor and record selections (clicks) by the client system 305 of a particular link on a web page of the third-party server 320. In some embodiments, a beacon comprising code (e.g., Javascript) on an advertiser web page containing a priority link is used. Each beacon has a unique identifier and is encoded for an invisible 1×1 pixel on the priority link. When a user/client system (via a browser) visits the web page and selects the priority link, the beacon contacts the base content server 310. In response, the base content server 310 records the user identifier of the client system (e.g., using the cookie stored on the browser), the unique identifier of the beacon, and the time and date of the recording to the log database 330.

As described above, the log database 330 contains records of online behavior for a plurality of users, each user identified by a unique user identifier (from User Identifier 1 to User Identifier N) in the log database 330. In some embodiments, for each user, the log database 330 includes advertisement identifiers of advertisements sent to the user (with time and date sent) and search queries and hyperlink selections received from the user (with time and date received).

As discussed below, the user events stored on the log database 330 are then used by the behavior metrics module 340 to determine the effect of an online advertising campaign on the online behavior of exposed users who have received at least one of the advertisements of the campaign. In some embodiments, the behavior metrics module 340 determines one or more metrics that indicate the effect of the campaign on the search and/or click (link selection) activity of the exposed users. The behavior metrics module 340 may be part of one or more servers, such as servers 240₁ to 240_{N}, including the base content server 310.

### II. Logging Events of Exposed and Unexposed Users

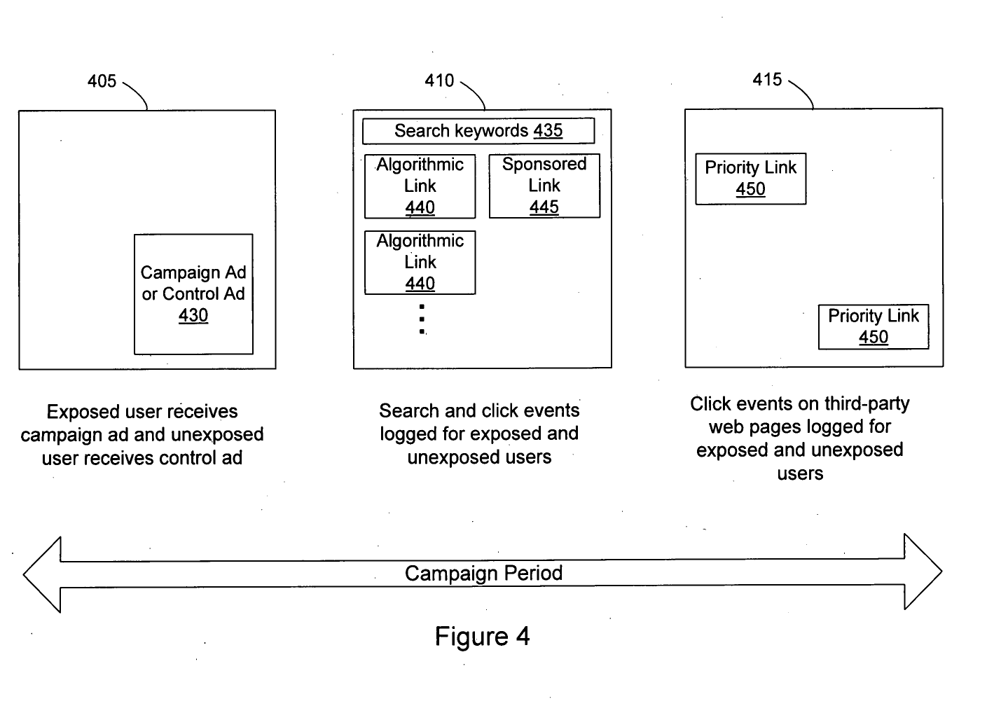

FIG. 4 is a conceptual diagram of a process for recording/logging online behavior of users during an advertisement campaign of an advertiser. The process is illustrated through three exemplary web pages 405 through 415.

The first web page 405 is typically generated and served by a base content server, although in other embodiments, it may be generated and served by another type of server. As shown in the first web page 405, during the campaign period, some users who are interacting with the base content server receive at least one advertisement 430 in the campaign, these users comprising a set of exposed users. Also during the campaign period, some users who are interacting with the base content server receive a control advertisement 430 (i.e., any advertisement that is not included in the campaign), these users comprising a set of unexposed/control users. The campaign or control advertisements may comprise any variety of forms including text, images, video, audio, animation, program code, data structures, hyperlinks, etc.

The second web page 410 is typically generated and served by a base content server, although in other embodiments, it may be generated and served by another type of server. As shown in the second web page 405, during the campaign period, some exposed and unexposed users who are interacting with the base content server perform search queries having search keywords 435. In some embodiments, the search queries of exposed and unexposed users are logged (as well as the time and date of each search query).

In response to a search query received from a user, the base content server will send base content to the user, where the base content may include one or more algorithmic links 440. As known in the art, algorithmic links are typically generated by a web search engine implementing a search algorithm that finds web pages on the Internet relevant to the keywords of a search query and generates links (referred to as algorithmic links) to the relevant web pages. Various methods are well known in the art to determine web pages that are relevant to keywords of a search query and are not discussed here. As such, an algorithmic link is typically not considered a sponsored link (i.e., is not paid to be displayed by an advertiser). The web search engine may be implemented, for example, on the base content server which then sends the generated algorithmic links to the user/client system that sent the search query.

Particular algorithmic links 440 sent to the users are links to one or more web pages associated with the campaign. For example, particular algorithmic links 440 may direct a user to a domain owned by the advertiser of the campaign (e.g., a web page/web site of the advertiser) upon selecting the algorithmic link 440. These types of algorithmic links are referred to as algorithmic advertiser links. In some embodiments, the selection by exposed and unexposed users of links leading to one or more web pages associated with the campaign are logged (as well as the time and date of each selection).

Also in response to a search query received from a user, the base content server may also send advertisements to the user that include one or more sponsored links 445. As known in the art, a sponsored link is an advertisement that is paid for by an advertiser to be displayed to users and is typically a link that leads to a domain owned by the advertiser paying for the sponsored link (e.g., a web page/web site of the advertiser). Typically, a sponsored link has associated keywords and is sent to a user when a search query containing one or more of the associated keywords is received from the user.

Some sponsored links 445 sent to users may be an advertisement associated with the advertisement campaign. For example, the sponsored link may be an advertisement of the campaign advertiser (the campaign advertiser paying for the sponsored link to be displayed to users) and lead to a web page of the campaign advertiser. Such sponsored links are referred to as sponsored advertiser links. In some embodiments, the selection by exposed and unexposed users of sponsored links 445 associated with the advertisement campaign are logged (as well as the time and date of each selection).

The third web page 415 is typically generated and served by a third-party server which is operated, for example, by the advertiser of the campaign. As shown in the third web page 415, during the campaign period, some users interact with a third-party server that serves web pages of the campaign advertiser having one or more predetermined priority links 450. Users may be directed to a web page of the campaign advertiser on the third-party server, for example, by selecting a received algorithmic or sponsored link or by directly typing the address of the web page. In some embodiments, a predetermined priority link 450 is a link that leads to a web page for eliciting a particular action by the user, such as buying a product or signing up for a service or account of the advertiser. In some embodiments, the selection by exposed and unexposed users of any priority links on web pages served by a third-party server are logged (as well as the time and date of each selection). The logging of selections of priority links may be implemented, for example, through use of a beacon on the priority link.

### III. Calculating Behavior Measurements and Metrics Indicating the Effect of the Campaign

After the data of exposed and unexposed user behavior events during the pre-campaign, campaign, and post-campaign periods have been recorded onto a log database 330 (the first stage), behavior measurements and metrics indicating the effect of the campaign can be determined (the second stage). In some embodiments, however, the first and second stages may overlap so that the second stage begins before the first stage ends. For example, user behavior measurements and metrics may be determined for the pre-campaign and campaign period while user event data is still being accumulated for the post-campaign period.

The user events stored on the log database 330 can then be processed by the behavior metrics module 340 which determines whether a user is an exposed or unexposed user, for example, by checking the advertiser-identifiers of all advertisements received by the user and comparing them to the advertiser-identifiers of the campaign advertisements. The behavior metrics module 340 can also determine the number of relevant searches and/or sponsored advertiser link, algorithmic advertiser link, or priority link selections made by each user and whether each search or selection occurred in the pre-campaign, campaign, or post-campaign periods.

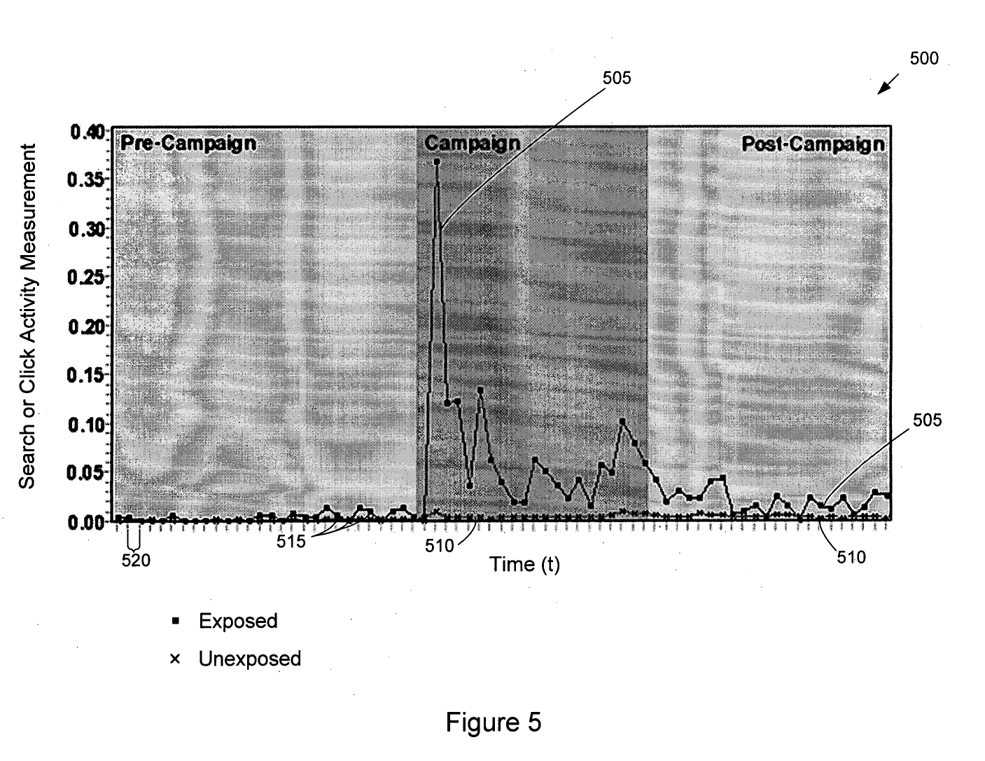

FIG. 5 is an exemplary graph 500 of measurements determined for accumulated user event data during pre-campaign, campaign, and post-campaign time periods. The y-axis of the graph 500 shows a particular user behavior measurement over time (x-axis). The graph 500 includes a first graph line 505 illustrating accumulated data for a set of exposed users and a second graph line 510 illustrating accumulated data for a set of unexposed users during pre-campaign, campaign, and post-campaign time periods. The first graph line 505 comprises a plurality of data points 515 indicated by a dot and the second graph line 510 comprises a plurality of data points 515 indicated by an “X”. As used herein, a time period (pre-campaign, campaign, and post-campaign periods) comprises one or more time units 520, where each data point reflects the data accumulated over one time unit 520. In the embodiments described below, one time unit 520 comprises one day, but in other embodiments, one time unit comprises another amount of time.

The set of exposed users are defined as users who receive one or more advertisements of the campaign during the campaign period, whereas the set of unexposed users are defined as users who do not receive any advertisements of the campaign during the campaign period. In determining which users will be in the sets of exposed and unexposed users, several methods may be used. In some embodiments, to maximize the effectiveness of the campaign, users who have shown a prior interest in the products or services of the advertiser may be selected for the set of exposed users. For example, users performing prior relevant search queries or sponsored advertiser link selections may be selected for inclusion in the set of exposed users. This selection method is reflected in the graph 500 of FIG. 5 where the set of exposed users have a higher incidence of a particular online behavior in the pre-campaign period than the set of unexposed users. In other embodiments, the set of exposed and unexposed users are selected randomly or pseudo-randomly to control for testing variables.

At what time the sets of exposed and unexposed users are determined may also vary. For example, the set of exposed and unexposed users may be determined at the beginning of the pre-campaign period (before any user events are logged). Or, the set of exposed and unexposed users may be determined during the campaign period (after user events during the pre-campaign period are logged). In these embodiments, the set of exposed and unexposed users can be constructed retroactively for the pre-campaign period. For example, any user receiving a campaign advertisement during the campaign period may be considered part of the set of exposed users during the pre-campaign period and any user not receiving a campaign advertisement during the campaign period may be considered part of the set of unexposed users during the pre-campaign period.

In some embodiments, the online activity of an exposed user is logged for a predetermined time duration (e.g., 28 days) after receiving a campaign advertisement. In some embodiments, during the campaign and post-campaign periods, an exposed user can change status to an unexposed user if the exposed user has not received an advertisement of the campaign for a predetermined time duration (e.g., 28 days). For example, if a user was exposed on day 1 of campaign (thus having the status of an exposed user), but then does not receive an advertisement of the campaign for 28 days thereafter, the user's status changes to an unexposed user. Note that during the campaign period, an unexposed user can change status to an exposed user upon receiving an advertisement so that the set of exposed and unexposed users during the campaign period (and hence, also the pre-campaign period) can continually change until the end of the campaign period. In some embodiments, however, during the pre-campaign period, an exposed user can not change status to an unexposed user and vice versa.

The y-axis of the graph 500 comprises values for a measurement of a particular user behavior for each day of the pre-campaign, campaign, and post-campaign periods. In some embodiments, a measurement of a particular user behavior reflects data accumulated for relevant search queries, clicks on sponsored advertiser links, clicks on algorithmic advertiser links, or clicks on priority link selections received from exposed or unexposed users over a particular time duration comprising one or more time units. Also, any combination of the these online activities can be measured and reflected in the graph 500, such as the total sum of clicks on sponsored advertiser and algorithmic advertiser links over a particular time duration.

As used herein, a measurement reflects data accumulated for a particular user behavior (search or click activity), for a particular time duration (one or more time units), and for a particular type of user (exposed or unexposed). For example, a measurement may be for relevant search queries during a day of the pre-campaign period for exposed users. As a further example, a measurement may be for clicks on priority links during the campaign period for unexposed users.

A measurement can be represented in various forms in various embodiments. For example, the measurement for relevant search queries for exposed or unexposed users may comprise the number of relevant searches received from exposed or unexposed users divided by the number of non-relevant searches received from exposed or unexposed users over a given time duration. Or, the measurement for relevant search queries for exposed users or unexposed may comprise the number of relevant searches received from exposed users or unexposed divided by the total number of exposed users or unexposed who were active on the network over the given time duration.

Measurements for click activity can also be represented in various forms in various embodiments. For example, the measurement for clicks on a particular type of link (sponsored advertiser, algorithmic advertiser, or priority link) for exposed or unexposed users may comprise the number of clicks from exposed or unexposed users divided by the number of times the link was received by the exposed or unexposed users over a given time duration. Or, the measurement for clicks on a particular type of link for exposed or unexposed users may comprise the number of clicks from exposed or unexposed users divided by the total number of exposed or unexposed users who were active on the network over the given time duration.

Note that in some embodiments, a measurement value of an online activity may be dependent on the number of users active on the network (e.g., interacting with the base content server) over a given time duration. In these embodiments, if a user is not active on the network, the online behavior of the user (or here, the lack of online behavior) is not be considered in determining the measurement value. For example, in producing a data point for a particular day, if there are approximately a total of 12,000 exposed users and 11,500 unexposed users through the pre-campaign, campaign, and post-campaign periods, on that day there may be only a small fraction of the total number of exposed and unexposed users that are active on the network and whose online activity is used to produce the data point for the day.

Different manipulations and forms of a measurement may be used without departing from the spirit of the invention. For example, a measurement for a particular online activity for a particular time period may comprise the average or weighted average of the measurements for the activity for all days of the time period. As a further example, a measurement may be multiplied by a predetermined factor (e.g., 1000) to make the values of the measurement more manageable. For example, in FIG. 5, the measurement value for the relevant search queries or link selections of exposed or unexposed users during a day may be determined by the equation:

[relevant searches or link selections/active users]*1,000.

For example, for relevant search queries of exposed users during a particular day, if there were 15 relevant searches received and 100,000 exposed users active on the network during that day, the data point value for that day would be (15/100,000)*1,000=0.15

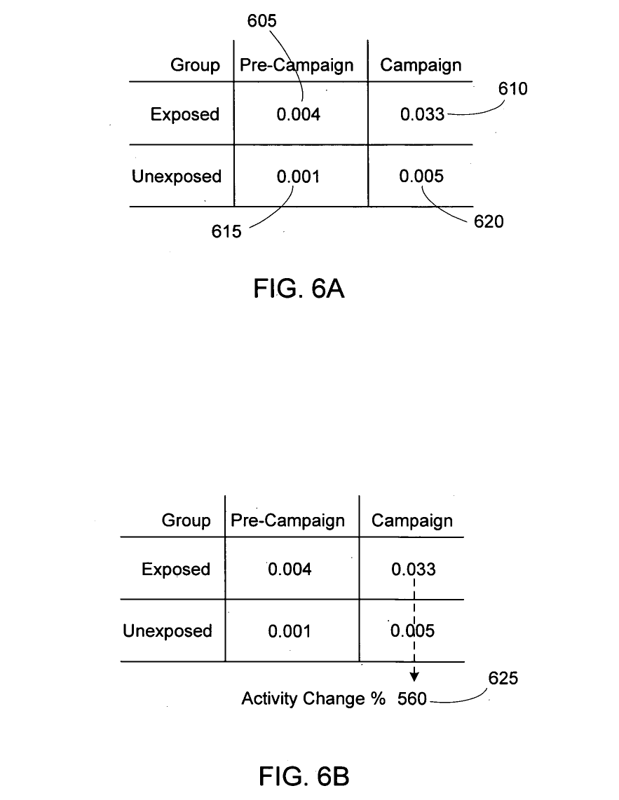

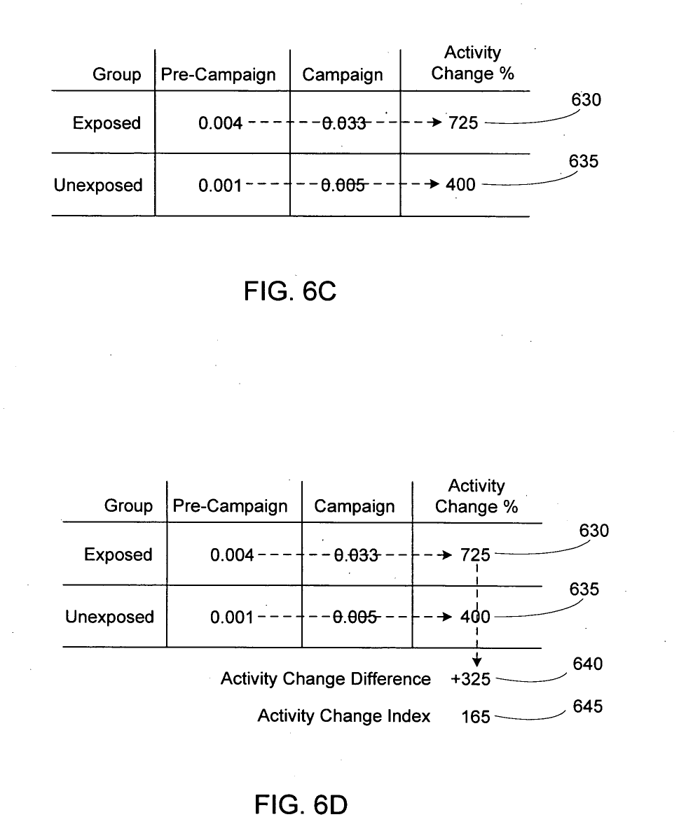

FIGS. 6A-6D are exemplary tables illustrating the different behavior measurements and metrics that may be determined from accumulated user event data. In the examples of FIGS. 6A-6D, the measurements for the campaign period include post-campaign data. In other embodiments, the measurements for the campaign period does not include post-campaign data and measurements for the post-campaign period are determined separately.

The measurements values shown in FIGS. 6A-6D, may be determined in a variety of ways. For example, each measurement value may reflect the total occurrence of a particular online activity by exposed or unexposed users divided by the total number of active exposed or unexposed users within the pre-campaign or campaign period, multiplied by 1,000. For example, if a total of 4 relevant searches were performed by unexposed users during the campaign period, and 1,000,000 unexposed users were active during the campaign period, the measurement value would equal (4/1,000,000)*1,000 or 0.004. As a further example, the measurements values may show weighted averages of the pre-campaign and campaign periods per 1,000 active users per day.

FIG. 6A is an exemplary table showing different measurements that may be taken from accumulated user event data. As shown in FIG. 6A, a first measurement 605 reflects the average rate of occurrence of a particular online activity (relevant searches or clicks on sponsored advertiser, algorithmic advertiser, or priority links) of exposed users during the pre-campaign period per day, a second measurement 610 reflects the average rate of occurrence of the online activity of exposed users during the campaign period per day, a third measurement 615 reflects the average rate of occurrence of the online activity of unexposed users during the pre-campaign period per day, and a fourth measurement 620 reflects the average rate of occurrence of the online activity of unexposed users during the campaign period per day.

For example, if the table relates to search queries, the first measurement value may indicate that an average of 0.004 relevant searches were performed by exposed users per 1,000 active exposed users per day during the pre-campaign period. If the table relates to sponsored advertiser link selections, the second measurement value may indicate that an average of 0.033 sponsored advertiser link selections were made by exposed users per 1,000 active exposed users per day during the campaign period. If the table relates to algorithmic advertiser links selections, the third measurement value may indicate that an average of 0.001 algorithmic advertiser link selections were made by unexposed users per 1,000 active exposed users per day during the pre-campaign period. Note that in some embodiments, the data for sponsored advertiser and algorithmic advertiser links are combined so that a measurement value indicates the average number of sponsored advertiser links plus algorithmic advertiser links made by exposed or unexposed users per 1,000 active exposed or unexposed users per day during the pre-campaign or campaign period. If the table relates to priority link selections, the fourth measurement value may indicate that an average of 0.005 priority link selections were made by unexposed users per 1,000 active exposed users per day during the campaign period.

As stated above, a user behavior measurement reflects data accumulated for a particular user behavior/activity, for a particular time duration, and for a particular type of user (exposed or unexposed). In contrast, a user behavior metric is a comparison between two or more user behavior measurements that reflects any disparity/difference between the two or more user behavior measurements. In other embodiments, a user behavior metric may be a comparison between two or more user behavior metrics that reflects any disparity/difference between the two or more user behavior metrics.

FIG. 6B is an exemplary table showing a first metric 625 that can be determined using the measurements shown in FIG. 6A. The first metric 625 indicates the disparity/difference of a particular online activity between exposed users and unexposed users during the campaign period. In some embodiments, the first metric 625 indicates the percent change of a particular online activity and is calculated by the equation: (Average rate of occurrence of the activity by exposed users during the campaign period−Average rate of occurrence of the activity by unexposed users during the campaign period)/(Average rate of occurrence of the activity by unexposed users during the campaign period*100). Thus, in the example shown in FIG. 6B, the first metric 625 is calculated as (0.033−0.005)/(0.005)*100=560% increase in the particular online activity. The first metric 625 indicates the percent change of a particular online activity, but in other embodiments, the first metric 625 is represented in a different form.

FIG. 6C is an exemplary table showing second and third metrics 630 and 635 that can be determined using the measurements shown in FIG. 6A. The second metric 630 indicates the disparity/difference of a particular online activity between exposed users during a campaign period (when the exposed users received an advertisement in the campaign) and a pre-campaign period (before the exposed users received any advertisement in the campaign). In some embodiments, the second metric 625 indicates the percent change of a particular online activity and is calculated by the equation: (Average rate of occurrence of the activity by exposed users during the campaign period−Average rate of occurrence of the activity by exposed users during the pre-campaign period)/(Average rate of occurrence of the activity by exposed users during the pre-campaign period*100). Thus, in the example shown in FIG. 6C, the second metric 630 is calculated as (0.033−0.004)/(0.004)*100=725% increase in the particular online activity. The second metric 630 indicates the percent change of a particular online activity, but in other embodiments, the second metric 630 is represented in a different form.

The third metric 635 indicates the disparity/difference of a particular online activity between unexposed users during a campaign period and a pre-campaign period. In some embodiments, the second metric 625 indicates the percent change of a particular online activity and is calculated by the equation: (Average rate of occurrence of the activity by unexposed users during the campaign period−Average rate of occurrence of the activity by unexposed users during the pre-campaign period)/(Average rate of occurrence of the activity by unexposed users during the pre-campaign period*100). Thus, in the example shown in FIG. 6C, the third metric 635 is calculated as (0.005−0.001)/(0.001)*100=400% increase in the particular online activity. The third metric 635 indicates the percent change of a particular online activity, but in other embodiments, the third metric 635 is represented in a different form.

A user behavior metric may also be a comparison between two or more user behavior metrics that reflects any disparity/difference between the two or more user behavior metrics. FIG. 6D is an exemplary table showing fourth and fifth metrics 640 and 645 that can be determined using the second and third metrics 630 and 635 shown in FIG. 6C.

The fourth metric 640 (“Activity Change Difference”) indicates the disparity/difference between the second and third metrics 630 and 635 and thus reflects the difference between the change in a particular online activity by exposed users from the pre-campaign to campaign periods and the change in the particular online activity by unexposed users from the pre-campaign to campaign periods (i.e., indicates how much more was the increase in the particular online activity by exposed users than expected). In the example shown in FIG. 6D, the fourth metric 640 is calculated as (725−400)=+325% Activity Change Difference. An Activity Change Difference of +325 means that users that were exposed to an advertisement of the campaign had an increase in the particular online activity of 325 points more than that of users who were not exposed to an advertisement.

The fifth metric 645 (“Activity Change Index”) indicates how many times larger any increase in a particular online activity by exposed users from the pre-campaign to the campaign periods is than any increase in the particular online activity by unexposed users from the pre-campaign to the campaign periods. In some embodiments, the fifth metric 625 is calculated by the equation: (Average rate of occurrence of the activity by exposed users during the campaign period/Average rate of occurrence of the activity by exposed users during the pre-campaign period)/(Average rate of occurrence of the activity by unexposed users during the campaign period/Average rate of occurrence of the activity by unexposed users during the pre-campaign period)*100. Thus, in the example shown in FIG. 6D, the fifth metric 645 is calculated as (0.033/0.004)/(0.0051.001)*100=165. An Activity Change Index of 165 means that users that were exposed to an advertisement of the campaign had an increase in the particular online activity that was 0.65 times larger than the increase in the particular online activity by users who were not exposed to an advertisement. An Activity Change Index of 100 means that there was no difference in the particular online activity between the exposed and unexposed users. And an Activity Change Index of less than 100 means that exposed users had a decrease in the particular online activity compared to unexposed users.

As such, the fourth and fifth metrics 640 and 645 reflect the effect that the advertising campaign has on the occurrence of a particular online activity by an exposed set of users before and after being exposed to the advertising campaign in comparison to the occurrence of the particular online activity by a control set of users (unexposed users) during the same time periods. Due to other concurrent advertising campaigns of the advertiser that are presented through other mediums (e.g., television, radio, etc.), there will be an increase in particular online activities in both the exposed and unexposed users regardless of the online advertising campaign. Thus, the fourth and fifth metrics 640 and 645 reflect the difference between these two increases in online activity in the exposed and unexposed users and isolates the effect of the online advertising campaign.

### IV. A Method for Logging User Events and Determining Behavior Measurements and Metrics Using the Events

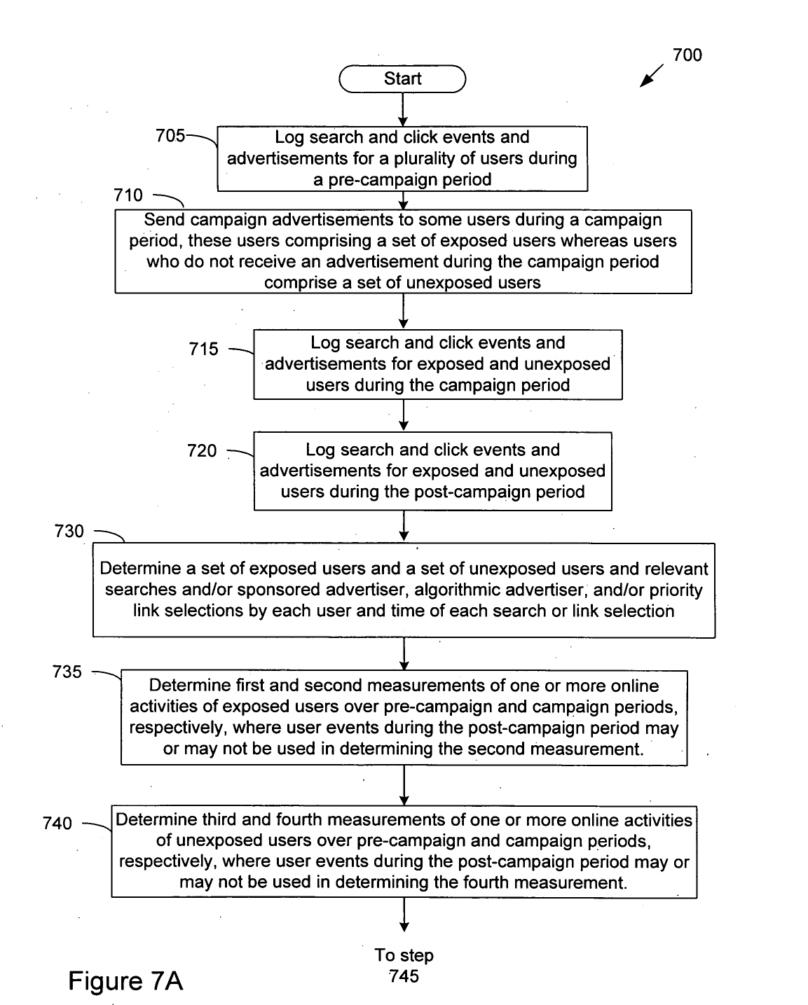

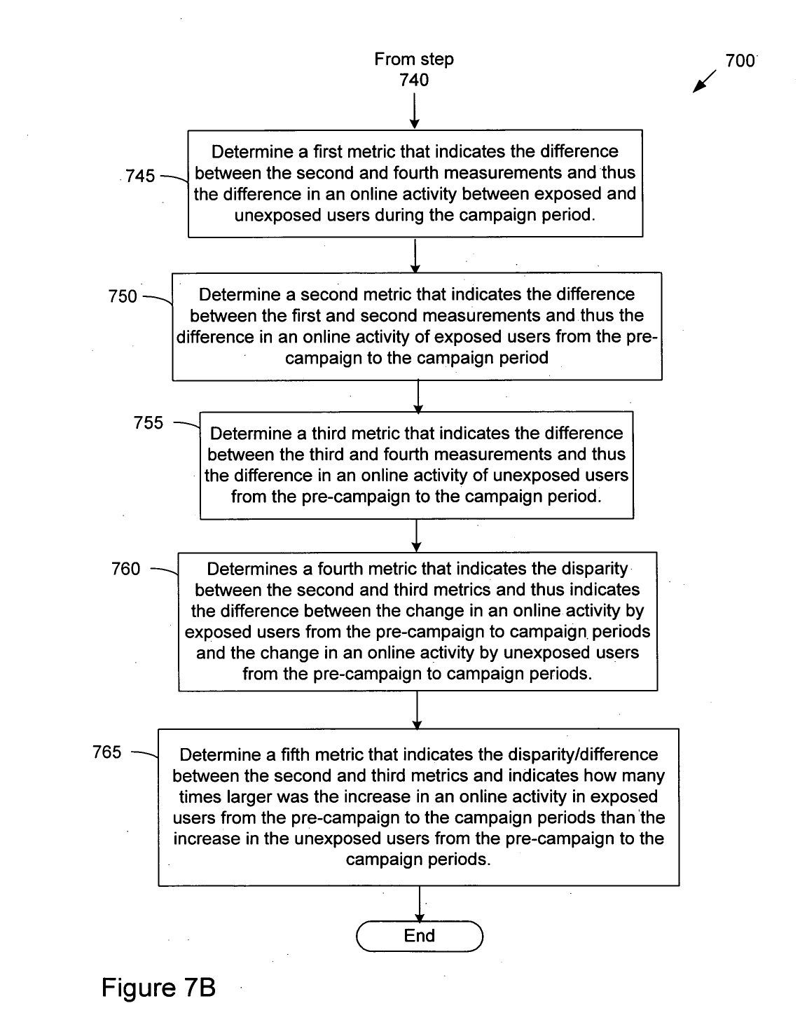

FIGS. 7A-B are flowcharts of a method 700 for measuring the effect of an online advertisement campaign on the online behavior of users who have received at least one advertisement. The advertisement campaign comprises a set of one or more advertisements of an advertiser that are sent to one or more users/client systems (via a network) during a campaign period. The set of advertisements has an associated set of one or more keywords that describe the set of advertisements, each advertisement in the set having a unique advertisement identifier. The method 700 comprises a first stage where user event data is logged and accumulated (in steps 705 through 720) and a second stage where user behavior measurements and metrics are determined using the accumulated user event data (in steps 730 through 765). In some embodiments, the first and second stages may overlap so that the second stage begins before the first stage ends. For example, user behavior measurements and metrics may be determined for the pre-campaign and campaign period which user event data is still being accumulated for the post-campaign period.

In some embodiments, the method 700 is implemented by software or hardware. In some embodiments, some steps of the method 700 are performed by a one or more servers (such as a base content server) and/or one or more client systems. The order and number of steps of the method 700 are for illustrative purposes only and, in other embodiments, a different order and/or number of steps are used.

The method 700 starts by logging (at 705) particular user events of a plurality of users during a pre-campaign period, each user being identified by a unique identifier (e.g., through a cookie stored on the user's browser). A pre-campaign period is a period of time prior to the campaign period when no users receive an advertisement of the campaign. In some embodiments, search queries and/or selections of links (e.g., sponsored advertiser links, algorithmic advertiser links, and/or priority links) made by the users are received by the base content server and recorded to a log database (along with the time and date of each search query or link selection). Advertisement identifiers of advertisements sent to the users are also logged (at 705) to the log database (along with the time and date the advertisement was sent) during the pre-campaign period.

The method 700 then sends (at 710) one or more advertisements of the campaign to a set of users during the campaign period, this set of users comprising the set of exposed users, whereas a set of one or more users who do not receive an advertisement during the campaign period comprise the set of unexposed users. The set of exposed and unexposed users may be determined randomly or using other methods and may be determined at various times, e.g., at the beginning of the pre-campaign period or during the campaign period (as discussed above).

The method 700 then logs (at 715) particular user events of the set of exposed and unexposed users during the campaign period. In some embodiments, search queries and/or selections of links made by the exposed and unexposed users are received by the base content server and recorded to a log database (along with the time and date of each search query or link selection). Advertisement identifiers of advertisements sent to the exposed and unexposed users are also logged (at 715) to the log database (along with the time and date the advertisement was sent) during the campaign period.

The method 700 then logs (at 720) particular user events of the set of exposed and unexposed users during a post-campaign period. A post-campaign period is a period of time after the campaign period when no users (whether exposed or unexposed) receive an advertisement of the campaign. In some embodiments, search queries and/or selections of links made by the exposed and unexposed users are received by the base content server and recorded to a log database (along with the time and date of each search query or link selection). Advertisement identifiers of advertisements sent to the exposed and unexposed users are also logged (at 720) to the log database (along with the time and date the advertisement was sent) during the post-campaign period.

The method 700 then determines user behavior measurements and metrics using the user event data for a plurality of users accumulated in steps 705 through 720. Using the accumulated user event data, the method determines (at 730) a set of exposed users and a set of unexposed users and, for each exposed or unexposed user, the number of relevant search queries and/or the number of sponsored advertiser link, algorithmic advertiser link, and/or priority link selections made by the user (and the date of each search or selection to determine whether the search or selection was in the pre-campaign, campaign, or post-campaign periods).

The method then determines (at 735) first and second measurements of one or more online activities (search or click activities) of exposed users over the pre-campaign and campaign periods, respectively. The method also determines (at 740) third and fourth measurements of one or more online activities (search or click activities) of unexposed users over the pre-campaign and campaign periods, respectively. In some embodiments, the data of user events during the post-campaign period are also used in determining the second and fourth measurements for the campaign period.

The method then determines (at 745) a first metric that indicates the disparity/difference between the second and fourth measurements, and thus indicates the difference in a particular online activity between exposed users and unexposed users during the campaign period. The method determines (at 750) a second metric that indicates the disparity/difference between the first and second measurements, and thus indicates the difference in a particular online activity of exposed users from the pre-campaign to the campaign period. The method determines (at 755) a third metric that indicates the disparity/difference between the third and fourth measurements, and thus indicates the difference in a particular online activity of unexposed users from the pre-campaign to the campaign period.

The method then determines (at 760) a fourth metric that indicates the disparity/difference between the second and third metrics and indicates the difference between the change in a particular online activity by exposed users from the pre-campaign to campaign periods and the change in the particular online activity by unexposed users from the pre-campaign to campaign periods. The method 700 finally determines (at 765) a fifth metric that indicates the disparity/difference between the second and third metrics and indicates how many times larger was the increase in a particular online activity in the exposed users from the pre-campaign to the campaign periods than the increase in the unexposed users from the pre-campaign to the campaign periods. The method 700 then ends.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

We claim:

1. A method for determining the effect of a set of one or more online advertisements on hyperlink selection behavior of a first set of one or more users, the method comprising:
determining a first number of selections of one or more predetermined hyperlinks made by the first set of users during a first time period when each user in the first set of users does not receive any advertisement in the set of advertisements;
determining a second number of selections of the one or more predetermined hyperlinks made by the first set of users during a second time period when each user in the first set of users receives at least one advertisement in the set of advertisements, the second time period being after the first time period; and
determining a first metric using the first and second numbers, the first metric reflecting any difference between the first and second numbers.

2. The method of claim 1, wherein:
the set of one or more online advertisements comprises advertisements of an advertiser; and
the one or more predetermined hyperlinks comprise one or more sponsored hyperlinks of the advertiser.

3. The method of claim 1, wherein:
the set of one or more online advertisements comprises advertisements of an advertiser; and
the one or more predetermined hyperlinks comprise one or more algorithmic hyperlinks to a web page of the advertiser.

4. The method of claim 1, wherein:
the set of one or more online advertisements comprises advertisements of an advertiser; and
the one or more predetermined hyperlinks comprise one or more hyperlinks in a web page of the advertiser.

5. The method of claim 1, further comprising:
determining a third number of selections of the one or more predetermined hyperlinks made by a second set of users during the first time period when each user in the second set of users does not receive any advertisement in the set of advertisements;
determining a fourth number of selections of the one or more predetermined hyperlinks made by the second set of users during the second time period when each user in the second set of users does not receive any advertisement in the set of advertisements;
determining a second metric using the third and fourth numbers, the second metric reflecting any difference between the third and fourth numbers; and
determining a third metric using the first and second metrics, the third metric reflecting any difference between the first and second metrics.

6. The method of claim 5, wherein the third metric reflects any disparity between the difference in selections of the one or more predetermined hyperlinks made by the first set of users from the first time period to the second time period and the difference in selections of the one or more predetermined hyperlinks made by the second set of users from the first time period to the second time period.

7. The method of claim 5, wherein the third metric reflects how many times larger any increase in selections of the one or more predetermined hyperlinks made by the first set of users from the first time period to the second time period is than any increase in selections of the one or more predetermined hyperlinks made by the second set of users from the first time period to the second time period.

8. A system for determining the effect of a set of one or more online advertisements on hyperlink selection behavior of a first set of one or more users, the system comprising:
a behavior module configured to:
determine a first number of selections of one or more predetermined hyperlinks made by the first set of users during a first time period when each user in the first set of users does not receive any advertisement in the set of advertisements;
determine a second number of selections of the one or more predetermined hyperlinks made by the first set of users during a second time period when each user in the first set of users receives at least one advertisement in the set of advertisements, the second time period being after the first time period; and
determine a first metric using the first and second numbers, the first metric reflecting any difference between the first and second numbers.

9. The system of claim 8, wherein:
the set of one or more online advertisements comprises advertisements of an advertiser; and
the one or more predetermined hyperlinks comprise one or more sponsored hyperlinks of the advertiser.

10. The system of claim 8, wherein:
the set of one or more online advertisements comprises advertisements of an advertiser; and
the one or more predetermined hyperlinks comprise one or more algorithmic hyperlinks to a web page of the advertiser.

11. The system of claim 8, wherein:
the set of one or more online advertisements comprises advertisements of an advertiser; and
the one or more predetermined hyperlinks comprise one or more hyperlinks in a web page of the advertiser.

12. The system of claim 8, wherein the behavior module is further configured to:
determine a third number of selections of the one or more predetermined hyperlinks made by a second set of users during the first time period when each user in the second set of users does not receive any advertisement in the set of advertisements;
determine a fourth number of selections of the one or more predetermined hyperlinks made by the second set of users during the second time period when each user in the second set of users does not receive any advertisement in the set of advertisements;
determine a second metric using the third and fourth numbers, the second metric reflecting any difference between the third and fourth numbers; and
determine a third metric using the first and second metrics, the third metric reflecting any difference between the first and second metrics.

13. The system of claim 12, wherein the third metric reflects any disparity between the difference in selections of the one or more predetermined hyperlinks made by the first set of users from the first time period to the second time period and the difference in selections of the one or more predetermined hyperlinks made by the second set of users from the first time period to the second time period.

14. The system of claim 12, wherein the third metric reflects how many times larger any increase in selections of the one or more predetermined hyperlinks made by the first set of users from the first time period to the second time period is than any increase in selections of the one or more predetermined hyperlinks made by the second set of users from the first time period to the second time period.

15. A method for determining the effect of a set of one or more advertisements on hyperlink selection behavior of a first set of one or more users, each user having received at least one advertisement in the set of advertisements, the method comprising:
determining a first number of selections of one or more predetermined hyperlinks made by the first set of users;
determining a second number of selections of the one or more predetermined hyperlinks made by a second set of one or more users who have not received any advertisement in the set of advertisements; and
determining a metric using the first and second numbers, the metric reflecting any difference between the first and second numbers.

16. The method of claim 15, wherein:
the set of one or more online advertisements comprises advertisements of an advertiser; and
the one or more predetermined hyperlinks comprise one or more sponsored hyperlinks of the advertiser or comprises one or more algorithmic hyperlinks to a web page of the advertiser.

17. The method of claim 15, wherein:
the set of one or more online advertisements comprises advertisements of an advertiser; and
the one or more predetermined hyperlinks comprise one or more hyperlinks in a web page of the advertiser.

18. A system for determining the effect of a set of one or more advertisements on hyperlink selection behavior of a first set of one or more users, each user having received at least one advertisement in the set of advertisements, the system comprising:
a behavior module configured to:
determine a first number of selections of one or more predetermined hyperlinks made by the first set of users;
determine a second number of selections of the one or more predetermined hyperlinks made by a second set of one or more users who have not received any advertisement in the set of advertisements; and
determine a metric using the first and second numbers, the metric reflecting any difference between the first and second numbers.

19. The system of claim 18, wherein:
the set of one or more online advertisements comprises advertisements of an advertiser; and
the one or more predetermined hyperlinks comprise one or more sponsored hyperlinks of the advertiser or comprises one or more algorithmic hyperlinks to a web page of the advertiser.

20. The system of claim 18, wherein:
the set of one or more online advertisements comprises advertisements of an advertiser; and
the one or more predetermined hyperlinks comprise one or more hyperlinks in a web page of the advertiser.
